(19) United States
(12) Patent Application Publication
(10) Pub. No.: US 2023/0258097 A1
(43) Pub. Date: Aug. 17, 2023

(54) ROTOR BLADE FOR A GAS TURBINE

(71) Applicant: MTU Aero Engines AG, Muenchen (DE)

(72) Inventors: Manfred FELDMANN, Eichenau (DE); Rudolf STANKA, Rattenkirchen (DE)

(21) Appl. No.: 18/108,743

(22) Filed: Feb. 13, 2023

(30) Foreign Application Priority Data
Feb. 14, 2022 (DE) 102022103345.7

(51) Int. Cl. F01D 5/30; F01D 11/00

(52) U.S. Cl. CPC F01D 5/3092; F01D 5/3007; F01D 11/006; F05D 2220/323; F05D 2250/711; F05D 2260/941; F05D 2260/37

(57) ABSTRACT

A rotor blade for a gas turbine, in particular an aircraft gas turbine, including a blade root, a blade neck that adjoins the blade root in the radial direction, an airfoil that adjoins the blade neck in the radial direction, a radially outer partition wall that forms a radially inner delimiting section of an annular space of a gas turbine, an axially front partition wall and an axially rear partition wall that are connected to the radially outer partition wall so that the partition walls surround the blade neck on three sides, the partition walls protruding beyond the blade neck in the circumferential direction. For placement in a blade root receptacle of a rotor disk, the rotor blade is provided with a blade root protective plate that is situated between the blade root and the rotor disk. The blade root protective plate includes at least one sealing section that extends in the axial direction from the front partition wall to the rear partition wall, and whose radial outer side is situated opposite from the radially outer partition wall when the blade root protective plate is situated at the blade root. One or multiple ribs are situated at the blade neck for supporting the sealing section and are integrally joined to the blade neck.

This claims the benefit of German Patent Application DE 102022103345.7, filed on Feb. 14, 2022 which is hereby incorporated by reference herein.

The present invention relates to a rotor blade for a gas turbine, in particular an aircraft gas turbine, including a blade root, a blade neck that adjoins the blade root in the radial direction, an airfoil that adjoins the blade neck in the radial direction, a radially outer partition wall that forms a radially inner delimiting section of an annular space of a gas turbine, an axially front partition wall and an axially rear partition wall that are connected to the radially outer partition wall so that the partition walls surround the blade neck on three sides, the partition walls protruding beyond the blade neck in the circumferential direction, and, for placement in a blade root receptacle of a rotor disk, the rotor blade being provided with a blade root protective plate that is situated between the blade root and the rotor disk, the blade root protective plate including at least one sealing section that extends in the axial direction from the front partition wall to the rear partition wall, and whose radial outer side is situated opposite from the radially outer partition wall when the blade root protective plate is situated at the blade root.

Directional indications such as “axial” or “radial” and “circumferential” are basically to be understood as relative to the machine axis of the gas turbine unless explicitly or implicitly stated otherwise.

### BACKGROUND

The blade root protective plates provided for the rotor blade form a boxlike profile with an elongated free sealing section in order to bridge and seal off a space between the front and rear partition walls.

### SUMMARY OF THE INVENTION

The problem has been recognized that plastic deformation or failure may result under long-term and/or very high stress due to high temperatures and/or vibrations at the sealing section. It is an object of the present invention to provide a rotor blade that allows a blade root protective plate, provided with the rotor blade for use in a system for a gas turbine, to better withstand fairly long-lasting stresses (high cycle fatigue (HCF)) and/or high stresses.

The present invention provides a rotor blade for a gas turbine, in particular an aircraft gas turbine, is provided, including a blade root, a blade neck that adjoins the blade root in the radial direction, an airfoil that adjoins the blade neck in the radial direction, a radially outer partition wall that forms a radially inner delimiting section of an annular space of a gas turbine, an axially front partition wall and an axially rear partition wall that are connected to the radially outer partition wall so that the partition walls surround the blade neck on three sides, the partition walls protruding beyond the blade neck in the circumferential direction, and, for placement in a blade root receptacle of a rotor disk, the rotor blade being provided with a blade root protective plate that is situated between the blade root and the rotor disk, the blade root protective plate including at least one sealing section that extends in the axial direction from the front partition wall to the rear partition wall, and whose radial outer side is situated opposite from the radially outer partition wall when the blade root protective plate is situated at the blade root. One or multiple ribs are situated at the blade neck for supporting the sealing section, in particular in order to radially outwardly support the sealing section, and are integrally joined to the blade neck. In this way, maximum temperature and/or vibration deformation of the sealing section is advantageously limited, and fairly long-lasting stresses on the sealing section are advantageously reduced. In particular, the sealing section thus also particularly advantageously has reduced creep behavior.

The sealing section when used as intended may be situated between a radial outer side of a disk hump in question of the rotor disk and the one or multiple ribs, and/or may shield an area of a or the radial outer side of a or the disk hump in question of the rotor disk.

The sealing section when used as intended may rest against the radial outer side of a or the disk hump in question of the rotor disk, and may in particular contact same, or be spaced apart from same with the formation of a gap.

In one preferred refinement, at least two ribs are provided. In particular, exactly two ribs are provided. Exactly two ribs are a particularly advantageous compromise between contact surface and increased weight in order to reduce the fatigue of the sealing section due to temperature and/or vibrations. The ribs may advantageously be uniformly distributed over the extension of the sealing section in the axial direction.

The one or multiple ribs particularly preferably have a convex design in the radial and/or axial direction, in particular without undercuts in the radial and/or axial direction. As a result, the rotor blade, in particular when it is a rotor blade designed as a cast part, may be manufactured in a particularly simple manner. The convex curvature of the ribs may have a design that is complementary, at least in part, with a surface of the sealing sections.

One aspect of the present invention relates to a system including a rotor blade described above and a blade root protective plate that includes at least one sealing section that extends in the axial direction from the front partition wall of the rotor blade to the rear partition wall of the rotor blade, and whose radial outer side is situated opposite from the radially outer partition wall of the rotor blade when the blade root protective plate is situated at the blade root.

In one particularly preferred refinement of the system, a press fit is provided between the rib(s) and the sealing section of the blade root protective plate. A direct power transmission between the sealing section and the blade neck is thus advantageously made possible, so that vibrations of the system have less influence on fatigue of the sealing section.

In one particular refinement, the number and/or the positions of the ribs correspond(s) to the number and/or position of a mode with the largest structural fatigue sites, occurring without ribs, along the longitudinal extension of the sealing section in the axial direction. A vibration of the sealing section is thus reduced in a targeted manner and with minimal additional weight.

In a further aspect of the present invention, the above-stated object is further achieved by a rotor blade disk including multiple rotor blade receptacles that are adjacently situated in the circumferential direction and into which a blade root of a particular rotor blade of the system is inserted, as described above, and including multiple disk humps that are formed between the rotor blade receptacles. The sealing section of the blade root protective plate with its radial inner side is situated opposite from a radial outer side of a disk hump in question. The sealing section may thus effectively prevent the penetration or drawing in of hot gas at the disk humps.

Lastly, the above object is further achieved by a gas turbine, in particular an aircraft gas turbine, that includes at least one such rotor blade disk. The rotor blade disk may in particular be part of a turbine stage of the gas turbine.

### BRIEF DESCRIPTION OF THE DRAWINGS

The present invention is described below by way of example and in a nonlimiting manner, with reference to the appended figures.

FIG. 1 shows a simplified schematic illustration of an aircraft gas turbine;

FIG. 2 shows a simplified schematic perspective illustration of a rotor blade together with a blade root protective plate and two ribs at the blade neck;

FIG. 3 shows a sectional illustration corresponding approximately to section line in FIGS. 1 and 2; and

FIG. 4 shows a simplified schematic perspective illustration of a rotor blade together with a blade root protective plate and one rib at the blade neck.

### DETAILED DESCRIPTION

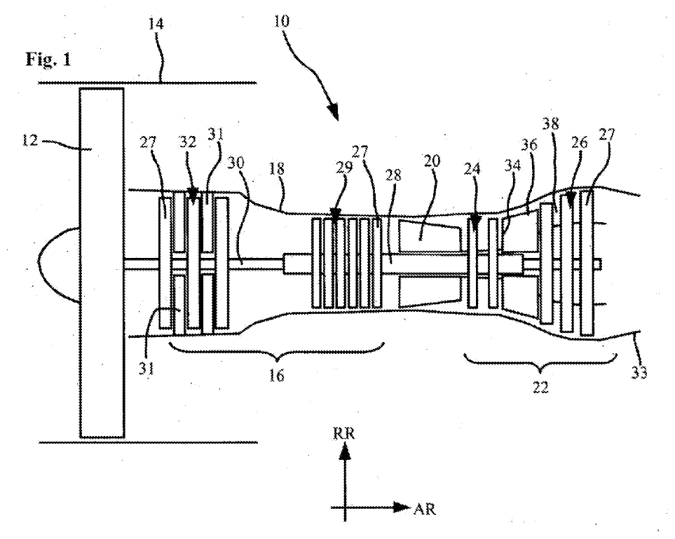

FIG. 1 schematically shows a simplified diagram of an aircraft gas turbine 10, which is illustrated as a turbofan strictly by way of example. Gas turbine 10 includes a fan 12 that is enclosed by an indicated casing 14. In axial direction AR of gas turbine 10, fan 12 is adjoined by a compressor 16 which is accommodated in an indicated inner housing 18, and which may have a one- or multistage design. Compressor 16 is adjoined by combustion chamber 20. Hot exhaust gas flowing out of the combustion chamber then flows through adjoining turbine 22, which may have a one- or multistage design. In the present example, turbine 22 includes a high-pressure turbine 24 and a low-pressure turbine 26. A hollow shaft 28 connects high-pressure turbine 24 to compressor 16, in particular to a high-pressure compressor 29, so that they are jointly driven or rotated. A further interior shaft 30 in radial direction RR of the turbine connects low-pressure turbine 26 to fan 12 and to a low-pressure compressor 32, so that they are jointly driven or rotated. Turbine 22 is adjoined here by a thrust nozzle 33, which is only indicated.

In the illustrated example of an aircraft gas turbine 10, a turbine intermediate housing 34 that is situated around shafts 28, 30 is situated between high-pressure turbine 24 and low-pressure turbine 26. Hot exhaust gases from high-pressure turbine 24 flow through radially outer area 36 of turbine intermediate housing 34. The hot exhaust gas then passes into an annular space 38 of low-pressure turbine 26. Of compressors 29, 32 and turbines 24, 26, rotor blade rings 27 are illustrated as an example. For reasons of clarity, guide blade rings 31 which are typically present are illustrated by way of example only for compressor 32.

The following description of one specific embodiment of the present invention relates in particular to the rotor blades, which may be inserted into a rotor blade ring 27 of compressor 16 or of turbine 22.

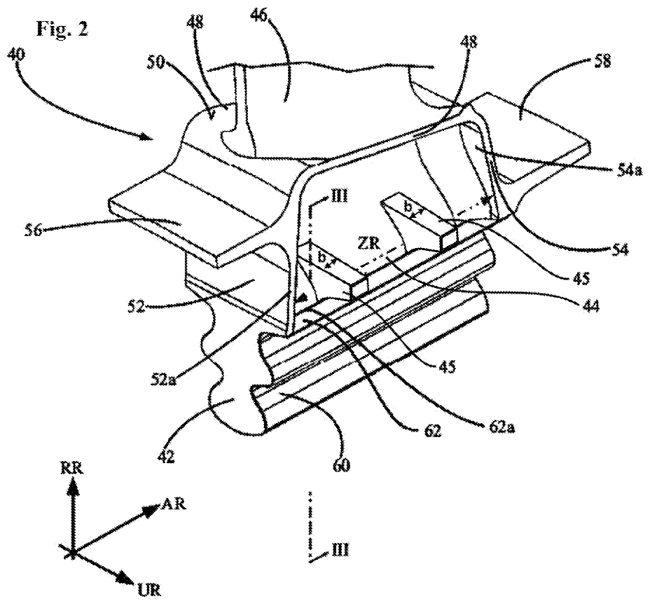

FIG. 2 shows a simplified schematic perspective illustration of a rotor blade 40 for a system according to the present invention. Rotor blade 40 includes a blade root 42. Blade root 42 is designed here by way of example with a so-called fir tree profile. Blade root 42 is adjoined by a blade neck 44 in radial direction RR. Blade neck 44 merges into airfoil 46.

Rotor blade 40 also includes a radially outer partition wall 48 situated between airfoil 46 and blade neck 44. Radial outer side 50 of partition wall 48 forms a portion of an annular space of a gas turbine when the rotor blade is installed as intended in a gas turbine. Rotor blade 40 also includes an axially front partition wall 52 and an axially rear partition wall 54. Axially front partition wall 52 and axially rear partition wall 54 are connected, in particular integrally joined, to radially outer partition wall 48. As is apparent from FIG. 2, partition walls 48, 52, 54 surround blade neck 44 on three sides. A front shroud section 56 or a rear shroud section 58 may be connected to partition wall 52, 54, respectively.

A blade root protective plate 60 is situated along blade root 42, in particular along its outer contour. Blade root protective plate 60 radially outwardly encompasses a sealing section 62. Sealing section 62 extends in axial direction AR from front partition wall 52 to rear partition wall 54. In particular, sealing section 62 bridges a space ZR that is formed between front partition wall 52 and rear partition wall 54. In particular, the sealing section is dimensioned in such a way that it bridges space ZR that is formed between a protruding section 52a of axially front partition wall 52 and a protruding section 54a of axially rear partition wall 54. Sections 52a, 52 protrude beyond blade neck 44 in circumferential direction UR. A radial outer side 62a of sealing section 62 is situated opposite from radially outer partition wall 48 in radial direction RR.

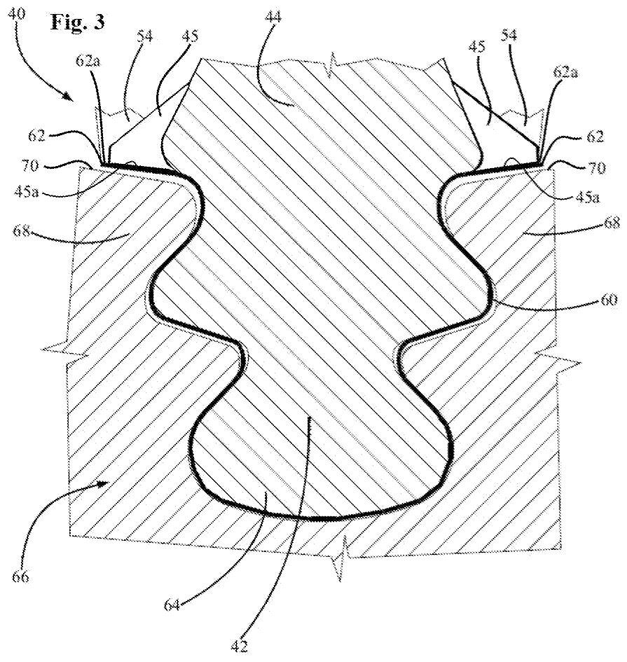

Sealing section 62 is supported in the radial direction by two ribs 45 of blade neck 44. Ribs 45 are situated within space ZR. Each of ribs 45 has a width b that is smaller than space ZR. Ribs 45 support sealing section 62 via contact surfaces 45a that have a design that is complementary with the surface of sealing section 62, in particular to allow a press fit to be formed with the surface of sealing section 62. It may also be provided that contact surfaces 45a (see, e.g., FIG. 3) of ribs 45 have a design that is complementary, at least in part, with sealing section 62 in the circumferential direction. In the present exemplary embodiment shown, ribs 45 support particular sealing section 62 over its entire extension in circumferential direction UR. It may also be provided that ribs 45 have a shorter design in circumferential direction UR, and thus at least partially support sealing section 62 in circumferential direction UR. It may be further provided that ribs 45 have a curved design at their edges and/or that ribs 45 are designed as a convexity of the blade neck.

FIG. 3 shows a simplified schematic sectional illustration, corresponding approximately to section line in FIG. 2, of blade root 42, which is accommodated in a blade root receptacle 64 of a rotor blade disk 66. Rotor blade disk 66 generally includes multiple rotor blades 40 that are adjacently situated in circumferential direction UR. A particular blade root 42 is accommodated between two adjacent disk humps 68 of rotor blade disk 66.

Also apparent from FIG. 3 is blade root protective plate 60, illustrated in simplified form as a thick black line. Blade root protective plate 60 radially outwardly encompasses sealing section 62. Sealing section 62 is situated opposite from a particular radial outer surface 70 of a disk hump 68 in question. In particular, sealing section 62 at least partially covers disk hump 68 in question. A portion of rear partition wall 54 is also apparent in the axial direction.

It is apparent from the overview in FIGS. 2 and 3 that partition walls 48, 52, 56 together with sealing section 62 form a type of box-shaped profile that surrounds or borders blade neck 44. Sealing section 62 may have an axial length that essentially corresponds to the axial length of blade root 42. In other words, it may be stated that partition walls 48, 52, 54 and blade neck 44 form a pocket that is radially downwardly open, and when blade root protective plate 60 is situated at blade root 42, sealing section 62 at least partially, in particular completely, closes the pocket radially downwardly.

The section in FIG. 2 extends in front of ribs 45, so that the ribs in FIG. 3 are not illustrated in a sectional view. Ribs 45 at their radially lower side each include a contact surface 45a with which they support sealing section 62.

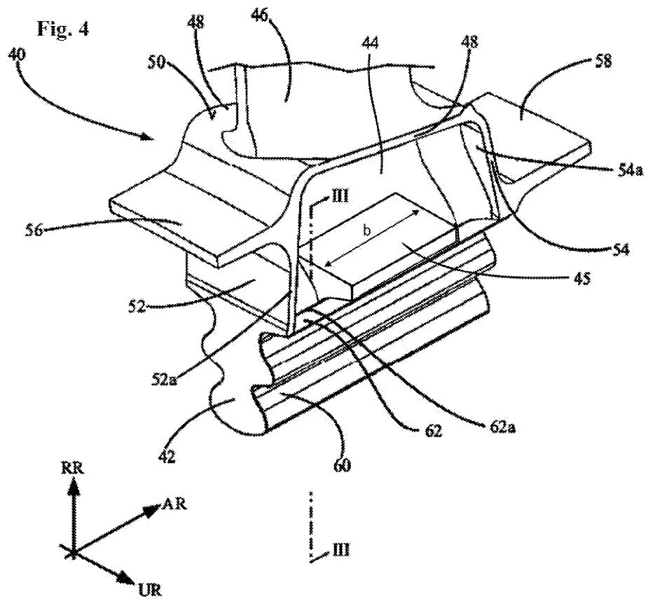

FIG. 4 shows an exemplary embodiment similar to that in FIG. 2, in which instead of two ribs, only one rib 45 having a greater width b is situated in space ZR.

### LIST OF REFERENCE NUMERALS

10 aircraft gas turbine
12 fan
14 casing
16 compressor
18 inner housing
20 combustion chamber
22 turbine
24 high-pressure turbine
26 low-pressure turbine
27 rotor blade ring
28 hollow shaft
29 high-pressure compressor
30 shaft
31 guide blade ring
32 low-pressure compressor
33 thrust nozzle
34 turbine intermediate housing
36 radially outer area
38 annular space
40 rotor blade
42 blade root
44 blade neck
45 rib
45a support surface
46 airfoil
48 radially outer partition wall
50 radial outer side of the partition wall
52 axially front partition wall
52a protruding section
54 axially rear partition wall
54a protruding section
56 front shroud section
58 rear shroud section
60 blade root protective plate
62 sealing section
62a radial outer side
64 blade root receptacle
66 rotor blade disk
68 disk hump
70 radial outer surface of the disk hump

What is claimed is:

1. A rotor blade for a gas turbine comprising:
a blade root;
a blade neck adjoining the blade root in the radial direction;
an airfoil adjoining the blade neck in the radial direction;
a radially outer partition wall forming a radially inner delimiting section of an annular space of a gas turbine;
an axially front partition wall and an axially rear partition wall connected to the radially outer partition wall so that the axially front and rear partition and radially outer walls surround the blade neck on three sides and protrude beyond the blade neck in the circumferential direction, the blade root for receiving a blade root protective plate for placement in a blade root receptacle of a rotor disk and for being situated between the blade root and the rotor disk, the blade root protective plate including at least one sealing section extending in the axial direction from the front partition wall to the rear partition wall, and having a radial outer side situated opposite from the radially outer partition wall when the blade root protective plate is situated at the blade root,
at least one rib situated at the blade neck for supporting the sealing section and being integrally joined to the blade neck.

2. The rotor blade as recited in claim 1 wherein the at least one rib includes two ribs.

3. The rotor blade as recited in claim 1 wherein the at least one rib has a convex design in the radial or axial direction.

4. The rotor blade as recited in claim 1 wherein the at least one rib is without undercuts in the radial or axial direction.

5. The rotor blade as recited in claim 1 wherein the rotor blade is for an aircraft gas turbine.

6. A system comprising: the rotor blade as recited in claim 1 and the blade root protective plate.

7. The system as recited in claim 6 wherein a press fit is provided between the rib and the sealing section of the blade root protective plate.

8. A rotor blade disk comprising:
a plurality of rotor blade receptacles adjacently situated in the circumferential direction, a blade root of a particular rotor blade of the system as recited in claim 6 being inserted into a particular blade receptacle of the plurality of blade receptacles, and including multiple disk humps formed between the rotor blade receptacles, the sealing section of the blade root protective plate with its radial inner side being situated opposite from a radial outer side of a respective disk hump, and in particular being situated between the radial outer side of the respective disk hump and the at least one rib, and shielding an area of the radial outer side of the respective disk hump.

9. A gas turbine including the rotor blade disk as recited in claim 8.

10. The gas turbine as recited in claim 9 wherein the rotor blade disk is part of a compressor stage.

11. The gas turbine as recited in claim 9 wherein the rotor blade disk is part of a turbine stage.

12. The gas turbine as recited in claim 11 wherein the turbine stage is a low-pressure turbine stage.

13. The gas turbine as recited in claim 9 wherein the gas turbine is an aircraft gas turbine.
